(19) United States
(12) Patent Application Publication
(10) Pub. No.: US 2012/0011440 A1
(43) Pub. Date: Jan. 12, 2012

(54) Method for Online Grid Associations

(76) Inventors: Theresa Kinney-Johnson, Dallas, TX (US); Steven H. Lieberman, Silver Spring, MD (US)

(21) Appl. No.: 13/107,424

(22) Filed: May 13, 2011

Related U.S. Application Data
(60) Provisional application No. 61/334,534, filed on May 13, 2010.

(51) Int. Cl. G06F 3/048

(52) U.S. Cl. 715/706

(57) ABSTRACT

A method of permitting account holders to communicate, interact and otherwise associate at least one primary grid account with additional grids by linking avatars via unique associations in a database between 3-dimensional online environments. A process is used where a user can register and make purchases relating to item listings and the association between the primary grid and the at least one additional grids. In addition, a process of delivery identification, linking avatars and listing and linking items also are combined.

### CONTINUITY DATA

This is a non-provisional application of provisional patent application No. 61/334,534 filed on May 13, 2010, and priority is claimed thereto.

### FIELD OF THE INVENTION

The present invention relates to a method of permitting account holders to associate at least one primary grid account to communicate or interact with additional grids by linking avatars via unique associations in a database between 3-dimensional online environments.

### BACKGROUND OF THE INVENTION

Social networking has become more and more popular in recent years. It is commonplace for people to type to one another online, exchange files with one another online, and share information with one another online.

While there are various venues in which one can social network, one of the growing venues is virtual worlds. Unlike instant messaging, emails, and information sharing, virtual worlds offer a much more immersive experience for the user. The user is not just sitting in front of a computer as the user's own identity; but rather, the user has an avatar that may or may not reflect attributes of the user. For example, a 30 year old man can have an avatar of an 80 year old female if he so desires. Similarly, a 75 year old man could have an avatar of a pretty 21 year old female. Essentially, a virtual world allows the user to, through an avatar, become part of a virtual world. As an avatar, the user participates in the virtual world.

The popularity of virtual worlds has encouraged various virtual worlds to emerge—some offer different venues or challenges, while others are simply another generic virtual world. It is commonplace for a user to accumulate a large inventory in one virtual world. However, there is not a way that the user can move the user's inventory from one virtual world to another. For example, if the user owns a wedding dress in a first virtual world, there is not a way that the user can take the wedding dress to a second virtual world. The user would need to accumulate enough credits in the second virtual world to buy a wedding dress in the second virtual world, even though the user already owns a wedding dress in the first virtual world. Thus, there is a need to allow users to move inventory from one virtual world to another.

Unfortunately, there is no known way to move inventory from one virtual world to another. Also referred to as grids, virtual worlds are independent of one another. There is a need for a way to allow users to have portable inventories so that items can be moved from grid to grid without issue.

Moreover, users often pay actual money to collect inventory in a virtual world, so the inventory should be portable. There is no reason why one grid should restrict movement of property that the user has purchased; in other words, inventory is something that should be and is owned by the user, so use on various grids should be unlimited.

The problem, as seen from the business side, is that content creators need a way to deliver their products on multiple grids through a central selling site while preserving and maintaining intellectual property rights. There is no way for creators to do such currently.

### SUMMARY OF THE INVENTION

The present invention is a method for online grid communication. The preferred embodiment of the present invention pertains to a 3-dimensional online grid application that essentially permits users from different locations to potentially converge and interact based on a network of grids contained within the 3-dimensional environment and its corresponding at least one server. The present invention, in its preferred embodiment relates to allowing a user of a primary grid to associate accounts across multiple grids with one another for communication or product delivery services that can be shared between at least one grid, also referred to as the first grid, and the additional grids.

The present invention, in its preferred embodiment, pertains to 3-Dimensional environments. The 3-Dimensional environments of the present invention are in communication with at least one server. At the same time, grids are programmed into and designed for the 3-Dimensional environment. As such, the method of the present invention provides a means for communication moving from the at least one server to the at least one grid, as well as the opposite direction with communication moving from the at least one grid to the at least one server.

One of the fundamental reasons for developing our grid was to provide virtual business owners with a home away from home through our security conscious grid—a quiet place to relax and work without so much worry and stress. Along the way we discovered we could offer creators a lot more. The present invention offers the following:

An affordable and safer retail alternative for creators to set up their stores to sell to users.

The ability to sell to creators' existing customers from inside or outside a particular grid via a selling portal.

Tools provided to creators to allow them to expand their market.

The ability for creators' customers to take purchased items beyond any one grid.

The ability to work with corporate clients who do not want to be locked into one particular grid.

The present invention was created because multiple grids led to isolation for developers, merchants, and regular users. The present invention's structure allows the distribution of assets between grids while respecting the original intellectual property rights holders associated with the assets.

### BRIEF DESCRIPTION OF THE DRAWINGS

FIG. 1 is a flow chart relating to the registration process of the present invention.

FIG. 2 is a flow chart of the credentials and data check process of the present invention.

FIG. 3 is a flow chart of the purchase process of the present invention.

FIG. 4 is a flow chart of the delivery identification process of the present invention.

FIG. 5 is a flow chart of the process of linking avatars of the present invention.

FIG. 6 is a flow chart of the process of listing and linking items of the present invention.

FIG. 7 is a flow chart showing an affiliated grid, import/export tool, and remote object storage system.

FIG. 8 is a flow chart showing a remote object storage system, SpotONSynergy, partial inventory transfer, and affiliated grids.

### DETAILED DESCRIPTION OF THE PREFERRED EMBODIMENT(S) OF THE INVENTION

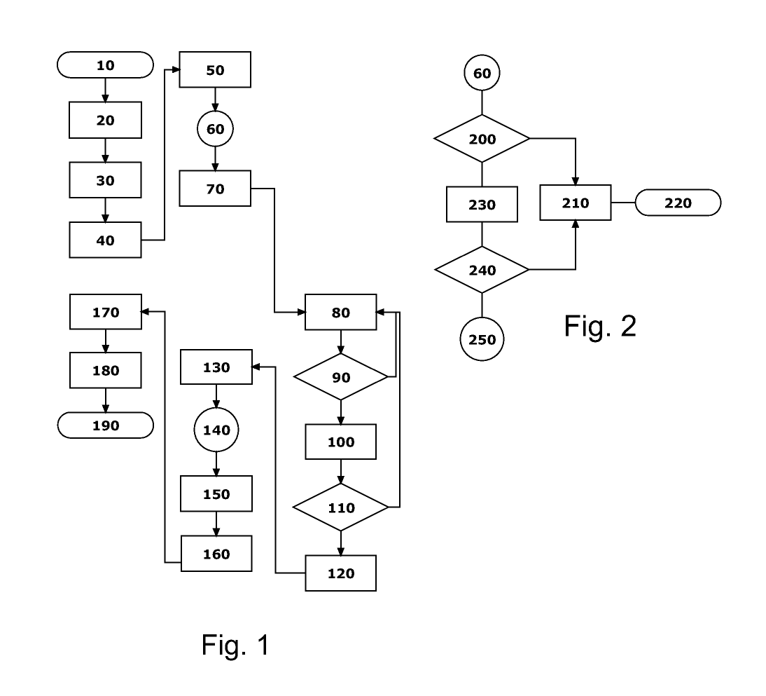

As shown in FIG. 1, the first step in the preferred embodiment of the present invention is for a user to start the registration process (10). This process begins with a new item box being rezzed in world (20). The user will then be able to create a communication method (30). What happens next is that data and information are posted to a backend (40) of the present invention. This includes items such as credentials, user information, identification, version of software/hardware, location of the user and all other related data. This information that is posted to the backend is transmitted either via at least one server to the at least one grid or at least one grid to the at least one server. The post is initiated for register via an item box (50). From there, the preferred embodiment of the present invention provides for a credentials and data check (60).

After the credentials and data check (60), the item box registers the user and grid association and confirms registration was successful (70). At this point, the system can confirm registration with the item box and loop through inventory items (80), with the present invention permitting this action via communication moving from the at least one server to the at least one grid, as well as the opposite direction with communication moving from the at least one grid to the at least one server. The preferred embodiment of the present invention then confirms the current owner permissions (90). This aspect of the present invention seeks to determine whether or not the item contained in the inventory is cleared for a copy and transfer for the current owner. However, if the inventory item is not capable of copy and transfer for the current owner, the present invention will revert back to the process of looping through inventory items (80). But if the item is copy and transfer for the current owner, the present invention allows for an item to be added to a list of items to be registered (100). The present invention then checks to see if more items exist (110). If more items do indeed exist, then the present invention again reverts back to looping through inventory items (80). If there are no more items, then the present invention allows for the posting of items to an at least one external server (120).

Through server to grid or grid to server communication, the post is initiated for the registration of the item list (130). An additional credentials and data check (140) is conducted before the present invention permits clear items for box (150). This means that the present invention permits the registration of a new item list for the user and grid. Registration is then confirmed with the item box (160). The present invention then permits the user to proceed to the next state (170) via server to grid or grid to server communication. In addition, start timer event is conducted for periodic checkups with the at least one server (180). Otherwise, the registration process concludes (190).

While FIG. 1 detailed the registration process of the preferred embodiment of the present invention, it is important to note the process relating to the credentials and data check (60/140/420/520). The preferred embodiment of this aspect is described in FIG. 2. As we see, the credentials and data check (60/140) allows for the confirming of credentials (200) process to take place. If the credentials fail, then the attempt is logged (210) with at least one server of the present invention and the process is exited (220). However, if the credentials pass, then the posted information is processed (230). The present invention then confirms all information is present and valid (240). If there is invalid information, the attempt is logged (210) with at least one server and the process is exited (220). If the information is determined to be present and valid, the process is permitted to continue (250).

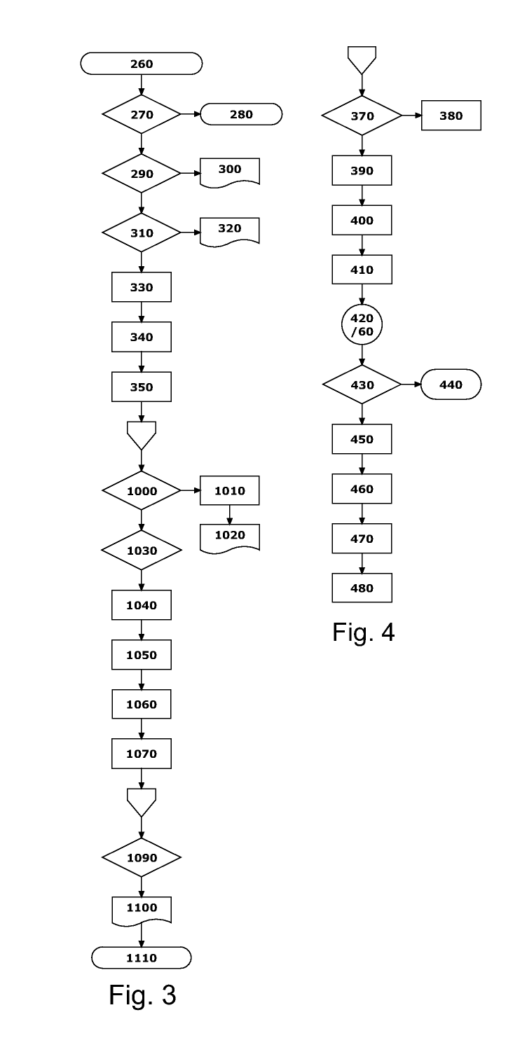

FIG. 3 is a view of the purchase process of the preferred embodiment of the present invention. As we see in FIG. 3, once the user purchase process is started (260), the present invention will check via conventional means to determine if it is a valid item (270). If it is not a valid item, an error page will be displayed (280) on the computer screen of the user. The error page in the preferred embodiment is a 404 error, page does not exist message, although any similar notification is envisioned. However, if the item is deemed valid, the present invention further examines via conventional means whether any of the primary grid's item boxes containing the item has been heard from in a specified or pre-selected time (290). If not, the present invention will lead the user to a screen that displays an error message indicating that the at least one server of the present invention has not made contact during a specific timeframe (300). If yes, the present invention then checks via conventional means to see if the user has sufficient funds (310). Such funds can be held in a special account, escrow, or otherwise made available for transfers within the present invention. If funds are found to be insufficient, the user is led to an error screen or page that informs the user of such insufficient funds (320). If sufficient funds are confirmed, the funds can be transferred between a buyer and a seller (330) in terms of transactions relating to the primary grid and additional grid. Upon funds transfer, a record is saved for the delivery (340). This is conducted via a unique identification. The primary grid item box is contacted with this unique identification such that contact is permitted with the at least one server (350). The item box receives unique delivery identification (360).

FIG. 4 is a flow chart that describes the preferred embodiment of the present invention in terms of the process when the item box receives unique delivery identification (360). The present invention will confirm via conventional means whether the credentials are proper (370). If it is deemed that the credentials are not proper, the present invention will ignore the delivery attempt and prevent further action from occurring (380). With proper credentials, a return confirmation (390) is presented to the user. The unique delivery identification is placed in communication with the at least one server (400). A request is then initiated for item delivery (410). That request is conducted through server to grid or grid to server communication. An additional credentials and data check is then conducted (420) as seen in FIG. 2. Once the credentials and data check is concluded, the present invention verifies via conventional means that the item linked to the unique delivery identification has been delivered onto the targeted grid (430). If no, the preferred embodiment is to lead the user to an error page (440) stating that the page does not exist. If yes, the present invention prepares the item delivery information for the item box, with the entry being marked as delivered (450). Return item delivery information is then conveyed (460). This includes target avatar and the item name. The present invention then parses the information (470) through server to grid or grid to server communication. The item is then sent to a designated avatar (480).

Going back to the point where the item box receives unique delivery identification (360), the present invention the confirms a response (1000). If there is no response, funds are removed from the seller's account and placed in escrow (1010). The present invention then via conventional means notifies the buyer that the funds will be held for a period of time as the present invention performs a delivery process (1020). Money in the preferred embodiment is refunded if delivery fails during this time period. In addition, after the confirmed response, the present invention looks to see if the listing is linked to other grid items as well (1030). If yes, compare linked grid listings to the linked avatars of the buyer (1040). From there, the present invention allows for the looking of avatars that are common with the listing linked associations (1050). The present invention saves a record for the delivery with a unique identification (1060). The respective grid item box is contacted with this unique delivery identification (1070). The unique delivery item box will then be received (1080). The present invention then checks to see if there are more relative avatars to loop through (1090). If not, the present invention displays purchase success page (1100). This ends the user purchase process.

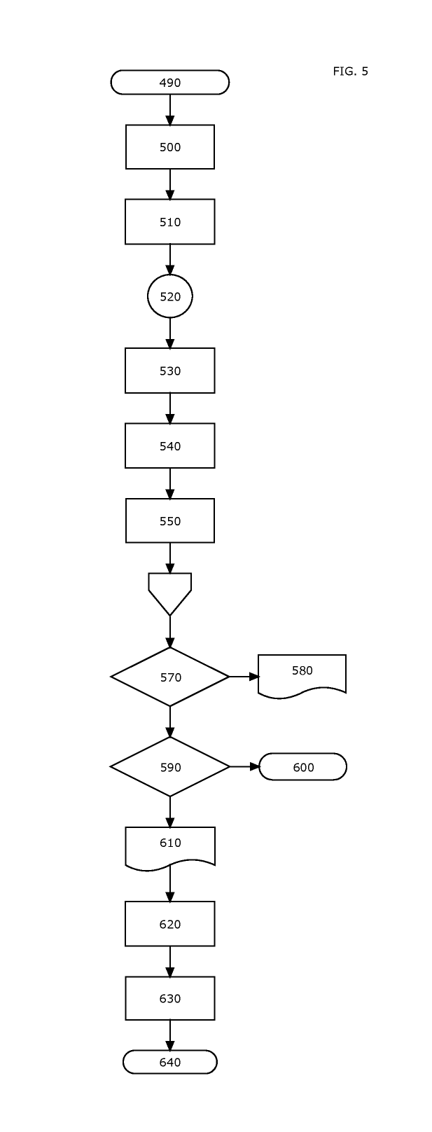

FIG. 5 describes the process of the preferred embodiment of the present invention of linking avatars (490). This is conducted by allowing the user to click an in-world item on a respective grid to retrieve a unique link (500). This respective grid can be the primary grid or additional grids. The invention will then post credentials, a user name and identification (510). Credentials and data are checked (520) in the manner described in FIG. 2. Once the process of FIG. 2 is completed, the present invention records data and generates the unique URL (530). The user then is permitted to return to the unique URL (540). The present invention will send the user the unique URL, as well as prompt the user to load the unique URL (550) through server to grid or grid to server communication.

The user then loads the unique page (560) gleaned from the unique URL. The present invention via conventional means ensures that the user is logged in (570). If the user is not logged in, the present invention provides the user with a prompt to login (580). Once the user is logged in, the user is redirected back to loading the unique page (560). The present invention also ensures that the unique URL is indeed valid (590). If the URL is not valid, the preferred embodiment of the present invention will lead the user to an error page (600) that indicates something along the lines of a 404 error that the page does not exist. However, if the URL is indeed valid, the present invention will notify the user via conventional means that the association between grids that they are about to make will be permanent for the particular grid (610). The user will then have the option of accepting the association (620) from which point the avatar and grid association is made (630). This means that all activity in the present invention will use and recognize the associations that have been made (630). From there, the linking avatars process is ended (640).

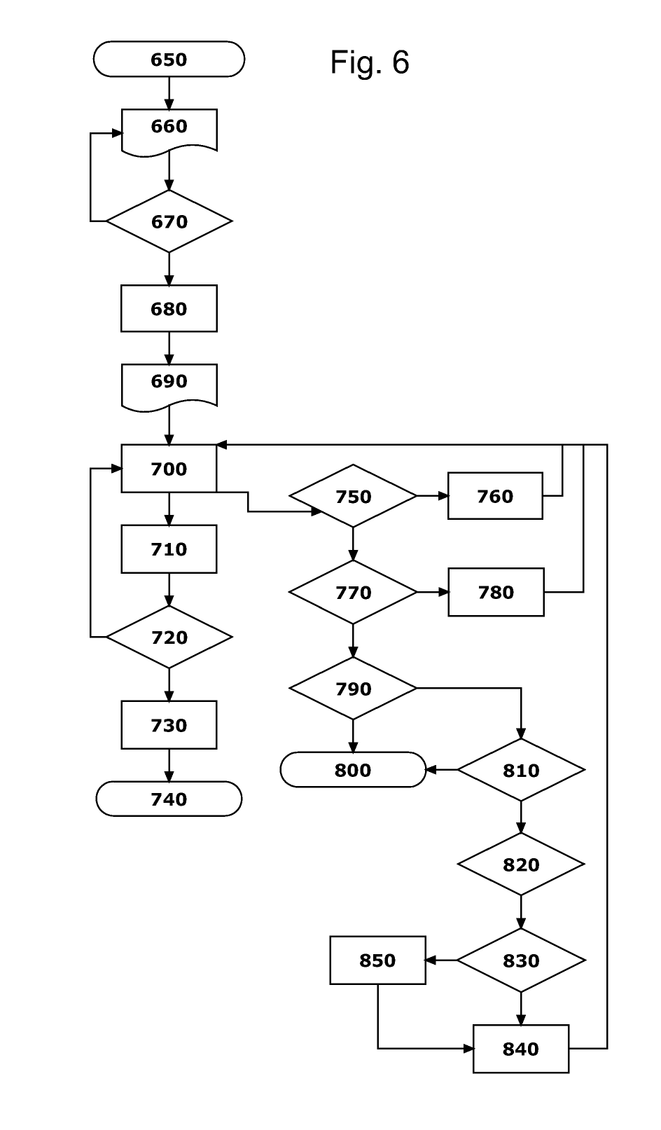

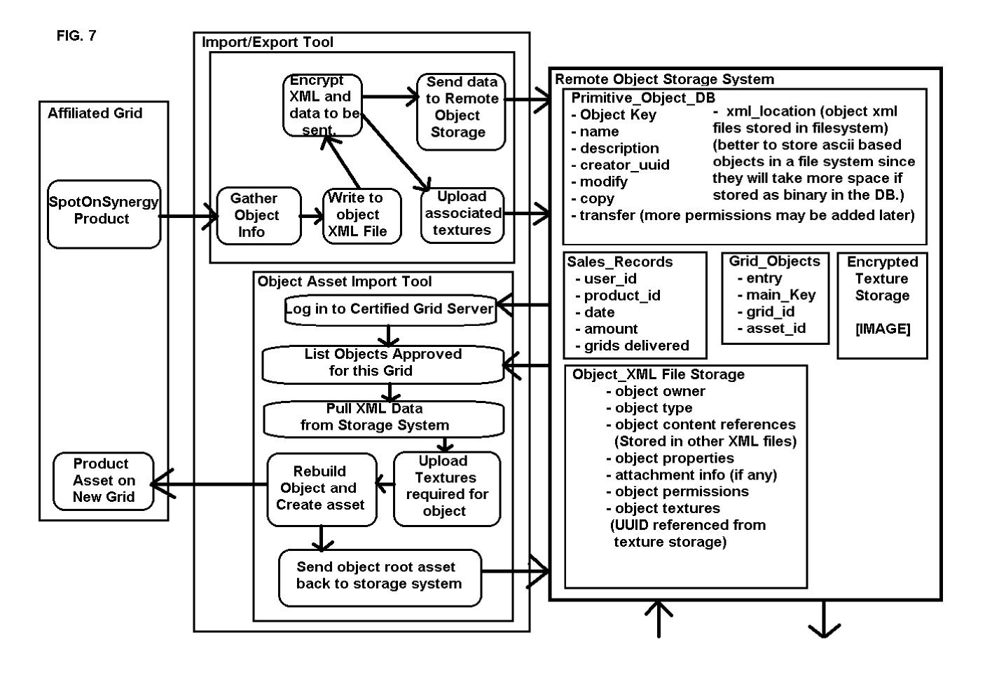

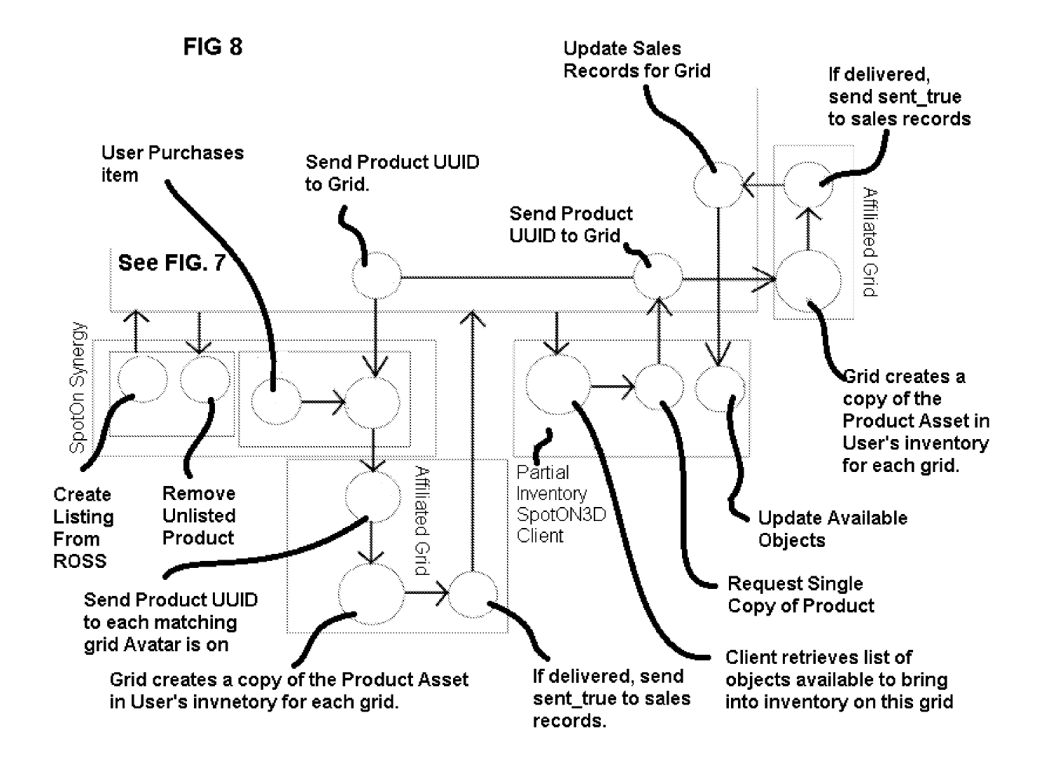

FIG. 6 is a flow chart relating to the process of listing and linking items. The present invention will display a start listing page after a user makes a selection of an item from the primary grid (660). This start listing page will then be posted where the present invention will seek confirmation that all data is correct (670). If the data is not correct, an edit page with the errors is provided in the preferred embodiment such that the user is ultimately reverted back to the start listing page display of 660. Once data is confirmed to be correct, the listing is posted (680). The present invention then offers to the user the ability to continue editing in order to link items from additional grids (690). The user can then edit such listings (700). An AJAX section is provided to the user and is used for selecting items from additional grids. The user then submits listings with linked items from the additional grids (710). Once again, the present invention ensures that all data is correct (720). If the data is not correct, an edit page with the errors is provided in the preferred embodiment such that the user is ultimately reverted back to the point of editing such listings (700). If the data is correct, the user can link the items from the additional grids to the primary grid. This would then conclude the listing and linking items (740) process of the present invention. It should be noted, however, that at the point where the user can edit such listings (700), the AJAX request is made to confirm that the user is searching for an item (750). If the user is searching for an item, the AJAX search will pull up all user records or a limited amount of user records for other grids (760). These other grids are based on an association of linked avatars that are not already listed. This then leads the user back to the point where the user can edit such listings (700).

However, if the user is not searching for the item, the user may be deleting a linked item (770). If this is the case, the present invention permits the removal of a requested deleted association from the listing (780). If the user is not deleting a linked item, the user also may be adding an item returned from a search (790). If not, then an error page is presented to the user indicating that the page does not exist (800). If the user is adding an item returned from the search, the present invention checks to see if the user has the requested item and grid combination (810). If not, then an error page is presented to the user indicating that the page does not exist (800). If yes, the present invention checks to see if the item is already linked to another listing (820). If that is the case, the error page is presented to the user indicating that the page does not exist (800). If the item is not already linked to another listing, the present invention seeks to ensure that the listing already has a linked listing for the grid (830). If not, the user will be afforded the ability to create a linked association from a cross grid delivery platform (840). If the listing already has a linked listing for the grid (830), then the linked listing for the grid is deleted (850) and the user will be afforded the ability to create a linked association from a cross grid delivery platform (840).

It should also be understood another embodiment of the present invention calls for a product server. The product server allows product information of an object—hereinafter referred to as a “product server object”—to be dropped into the server box and to be sent to a central point of sale web site as an unlisted product. The product server object should be delivered to an avatar upon a grid associated with an account of the purchaser of the product.

The Product Server should preferably have a limit of 51 objects. This is a limit placed to shorten the time searches take for the product within the server box to be delivered. Multiple product servers have the ability to hold identical objects but only be listed once upon an account. This allows redundant points of delivery in case one product server goes down. The product can still be delivered from the secondary server.

The present invention, in one embodiment, has a kiosk. The purpose of this kiosk is to allow users to link their avatars on an approved grid with their equivalent avatar on an account. The kiosk will take a user's avatar UUID on a current grid and associate it directly with the user's account avatar. One avatar from each grid can be associated with the user's equivalent avatar on the user's account. Once linked, if the product that the user purchases from the user's account is offered on the grid that the user has linked from, the product will be delivered to both the user's account as well as the secondary grid that the user has linked the user's avatar from. The kiosk itself simply redirects the user to the account site with the user's avatar UUID. All actual work is done upon the account site.

The present invention provides for product listing and point of sale. Accounts of the present invention should be based upon avatar accounts and the avatar accounts associated passwords. There exists functionality to allow an account user, with accounts on approved grids, to associate avatars from grid to grid for use of objects. Each avatar account has list editing abilities and can be setup for sale of objects. Each product listing begins as an unlisted item. Each listing has a product description and image associated with it which the user inputs or uploads. Each product is set into an associated category, (clothing, tools, etc.) by the creator. Each product can be set as an approved item and associated with other equivalent products on approved grids if those products exist and are places in product servers. Listings can be removed, as well, if the creator does not want a product listed. Users can search for a product by product name or by creator name.

The user can purchase an item via the present invention. The funds for the purchase will be withdrawn from their avatar's current balance. The present invention provides that the creator's product server box is contacted and is instructed to deliver the item to the avatar logged in to the system of the present invention. The product is also delivered to related avatars if the avatar is linked to any other avatars on approved grids and the product is set up to be delivered to those grids.

It should be understood that the present invention calls for a database that allows for listings on a server, trusted listings (listings that are associated with various avatars), avatar verifications from approved grids, and delivery of records and confirmations.

The present invention employs a Remote Object Storage System (ROSS). A product is created by a designer. The product could be any type of the standard types of objects currently supported and potentially be expanded to new object types. Current supported object types are the following:

Per the present invention, a product is scanned from inventory for the product's properties. The scanning may be built into the client or may be a separate application. The scanner is a tool that would only function on approved grids. If necessary, the object is pulled out of inventory and attached to the avatar to get further information on the prim structure and contents.

An encrypted XML is created containing the data of each object being backed up to storage services. The backup XML files are stored in an ordered file system tree. In addition, a product's object_key, name, description, and creator_uuid are stored in an ordered file system tree. The reason for choosing a file system tree for storage is because the files are basic ascii documents. To store them in a database or as compressed files is likely to increase the XML file size rather then decrease it. Textures specific to a product are stored encrypted in a texture database or storage system. The texture name will be the same as its asset UUID. The asset UUID is referenced in the product's object xml file.

The present invention provides for creation of listings from a remote object storage system. When an product is successfully scanned and placed into the storage system, an “Unlisted Item” entry is made for that product. When editing the listing for the first time, the creator will find that some of the listing elements will have default entries based upon the properties of the object scanned. Editing the listing, per the present invention, presents the user/creator with the following options:

Product Title: This initially will be the name of the created product object.

Product Category: Choose from a preset list of categories that most suits the product's purpose.

Product Description: By default this will be set to the product's in world description. There will be plenty of room for the creator to detail this description further.

Price: Selling price of the product.

Permissions: Permissions on the product are initially set to those read by the product scanner when uploading the item to the storage system. These may be changed by the creator if needed.

Product Image: Uploadable file image of the product. More than one image may be loaded for the product.

Product Rating: A toggle if the product is mature or not. Optionally, it is a product property. It may be expanded with further rating flags.

Once listing has been submitted, it will appear as a product for sale per the present invention. The creator has a selection of certified grids that have partnered as part of the present invention. Product listings can be added or removed from each certified grid box. Including a product in a certified grid box makes that item available to be brought in to the certified grid using an Object Asset Creation Tool. A listing can be edited and updated at any time. A listing can be removed—a listing can be toggled to be no longer being displayed—then the product will not be shown. The product status will be shown as “Unlisted Item.”

Per the present invention, a creator has the option of removing an “Unlisted Item” product from the present invention entirely—this includes removal from the remote object storage system. Removal of an “Unlisted Item” only removes the object details and references from the remote object storage system and the present invention, but it does not remove the object's asset from the certified grids that the object has been delivered to. The assets on the certified grids need to be maintained because the product has already been distributed and in use on these grids. However, the “Unlisted Item” object no longer will be distributed through the present invention.

The present invention offer an Object Asset Creation Tool to introduce an object asset to a new certified grid. Certified grids are other grids that a creator may choose to deliver a selection of the creator's products to. Initially, an asset for the object needs to be created on the new grid. The asset must preserve the creator's name and the permissions the creator chose for the product. The creator will need to import the product into the new grid. This can be done with an import tool either built into the client or made as an independent application, possibly tied into the same application as the export tool. This tool only functions via the present invention and other approved grids of the present invention.

According to the present invention, the creator needs to be logged in to the certified grid under the same name that the creator uses for the creator's product listings. The client will only log into certified grids. Once logged in, the Object Asset Creation Tool checks, via the present invention, to see what objects have been approved for a grid. The approved objects are displayed in the importer. The Object Asset Creation Tool then pulls the encrypted xml data and additional information from the storage system. The data can now be decrypted and used to recreate the product on a certified grid.

Once the product has been created, the main asset uuid for the created object is sent back to the Remote Object Storage System. The main asset uuid will be used to reference the product as it exists on the new grid. This reference is important as it will be used to locate product items via the present invention, and it enables associated grids to take delivery.

The present invention also provides product purchase and delivery. The buyer chooses and purchases a product via the present invention, and those actions initiate the delivery process to the buyer's grids. The buyer still needs to link its avatars on the certified grids on which the buyer has accounts to the main account of the present invention in order to make the purchase. Once the purchase has been made, the delivery system looks at which grids the buyer has accounts on. For each grid the user is on, the system checks to see if the product is available to be delivered. If the product is allowed, the Remote Object Storage System makes a direct request to the grid to deliver the product to the buyer's inventory. The storage system makes a direct call to the grid asset services sending the asset uuid and buyer information. The grid asset server makes an instance of the asset and places it in the purchaser's inventory. The delivered product retains the creator's name, and the permissions for the product will change to fit the permissions that the creator sets for the next user of the product. A record of the purchase is archived. The record can be used to allow the buyer to have access to the item on grids that the buyer may not have a presence on if the creator has allowed product access to that grid, and the grid is a certified associated grid of the present invention.

The present invention also provides for partial user inventory transfers between grids. If users create accounts on a previously existing certified grid, they may want to bring some of their inventory over with them. This is accomplished using a database that keeps a record of the users' purchases according to the present invention. The record is needed to keep track of sales—both on the buyer and seller end. However, the record serves a dual purpose as well—that is, it offers copies of items to the buyer on grids that the buyer has pre-approved. A user, with a new account on an existing grid, can use an inventory restore tool to access items that that user may have purchased while on another grid. Access to items is dependent on the creator of those items making those items available upon the grid. The user can then request a single copy of an item on the grid that the user's new account exists on, provided that the user's main avatar account of the present invention (that the user is linked to) has purchased access to that item. If the user's main avatar account of the present invention (that the user is linked to) does have access to that item, then upon successful request, the item will be delivered to the user using the same distribution system provided for product sales, but limited to the single grid account making the request. Once the user has received its copy of the item, the user's sales record will record that the user has received the product on the grid that the user requested from. The user will not be able to receive any other copies of that item unless the user is actively purchasing the same product again from the creator through the present invention.

Having illustrated the present invention, it should be understood that various adjustments and versions might be implemented without venturing away from the essence of the present invention.

I claim:

1. A method for online grid associations, comprising:
a first avatar on a first grid;
a second avatar on a second grid;
a server, in communication with said first grid and said second grid, said server configured to sync attributes of said first avatar with attributes of said second avatar contemporaneously.
